(19) United States
(12) Patent Application Publication
(10) Pub. No.: US 2025/0381605 A1
(43) Pub. Date: Dec. 18, 2025

(54) METHOD AND SYSTEM FOR FORMING A BATTERY TRAY FOR AN ELECTRIC VEHICLE

(71) Applicant: FCA US LLC, Auburn Hills, MI (US)

(72) Inventors: Zuohong Fu, Shanghai (CN); Haifeng Guo, Shanghai (CN); Junjie Zhou, Shanghai (CN); Hongyu Wang, Shanghai (CN); Xiaozhou Jiang, Shanghai (CN)

(21) Appl. No.: 18/742,236

(22) Filed: Jun. 13, 2024

(51) Int. Cl. B23C 3/12

(52) U.S. Cl. CPC B23C 3/12

(57) ABSTRACT

A method and system of machining a battery tray for an electric vehicle includes scanning a surface of the battery tray in a measurement system, generating a measurement signal based on scanning, communicating the measurement signal to a machining machine, inserting a battery tray into the machining machine, said battery tray comprising a weld and a beam and machining the weld and the beam based on the measurement signal.

### FIELD

The present disclosure relates to a battery tray for an electric vehicle, and more particularly to a method of efficiently forming the battery tray.

### BACKGROUND

This section provides background information related to the present disclosure which is not necessarily prior art.

Battery trays are used to hold the battery for an electric vehicle. The battery tray is welded together then machined to obtain flatness for later in the assembly process. To obtain flatness, the battery tray is inserted into a milling machine, measured then machined. However, in high production scenarios, the process consumes too much time.

### SUMMARY

This section provides a general summary of the disclosure and is not a comprehensive disclosure of its full scope or all of its features.

The present disclosure provides a measurement outside the machining device. More specifically, measurement is performed before the tray is inserted into the machine so that machining can start immediately. In one example, the overall processing time for a battery tray was reduced by over 72%.

In one aspect of the disclosure, a method of machining a battery tray for an electric vehicle includes scanning a surface of the battery tray in a measurement system, generating a measurement signal based on scanning, communicating the measurement signal to a machining machine, inserting a battery tray into the machining machine, said battery tray comprising a weld and a beam and machining the weld and the beam based on the measurement signal.

In another aspect of the disclosure, a system for processing a battery tray includes a machining robot disposed within a machine frame. The robot has a robot controller. A measurement system is disposed outside the machine frame and generates a battery tray measurement signal and communicates the battery tray measurement signal to the machine frame. The machining robot machines the battery tray based on the battery tray measurement signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a battery tray processing system having a measurement system and a machining system.

FIG. 2A is a view of a top surface of the battery tray.

FIG. 2B is a view of the bottom of a battery tray.

FIG. 2C is a side view of the joint between front/rear and side beams of battery tray illustrated in FIG. 2A and 2B.

FIG. 3 is a side view of the measurement system.

FIG. 4 is a flowchart of a method for processing the battery tray.

Corresponding reference numerals indicate corresponding parts throughout the several views of the drawings.

### DETAILED DESCRIPTION

Example embodiments will now be described more fully with reference to the accompanying drawings.

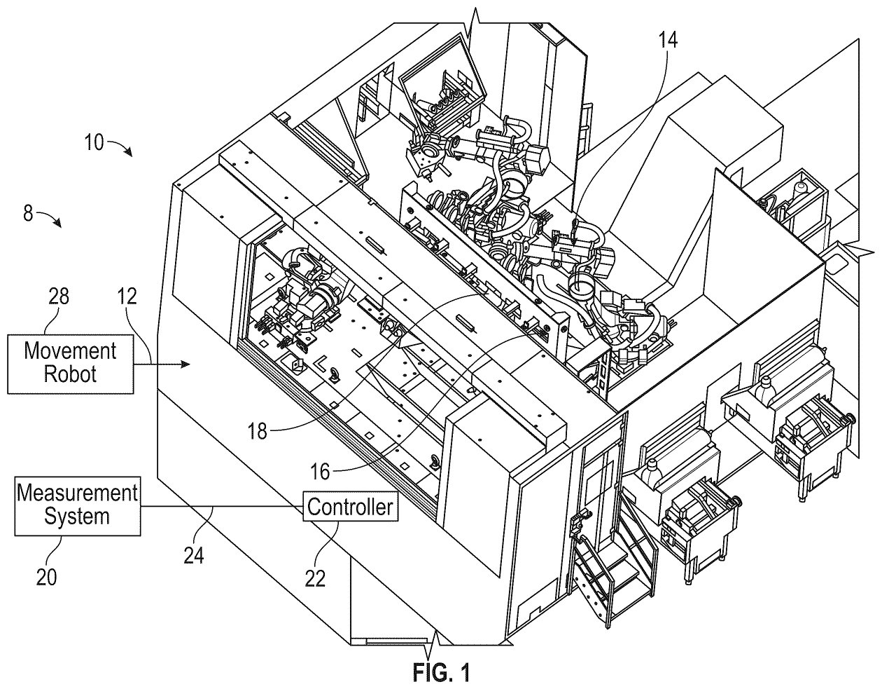

Referring now to FIG. 1, a battery tray forming system 8 has a machining station 10. The machining machine or station 10 is illustrated having a machine frame 12 that houses at least one machining robot 14. The machining robot 14, in this example, is shown relative to a battery tray fixture 16 that holds a battery tray 18. The machining robot 14 used in this example is a milling robot that machines selected portions of the battery tray 18 and the welds associated therewith.

A measurement system 20 is disposed adjacent to the machining station 10 and scans and measures misalignment for beams at joint area in an upper surface of a battery tray as described below. The measurement system 20 provides a measurement signal to a robot controller 22 of the machining station 10 which is used to control the machining robot 14. The measurement system 20 communicates the measurement signal containing data to the robot controller 22 through an electrical connection 24. Examples of the electrical connection 24 include a wireless network (Internet, Bluetooth) or in a wired network (ethernet, direct wire).

A movement robot 28 is used to move the welded battery tray 18 between the measurement system 20 which allows the battery tray 18 to be measured and the machining station 10.

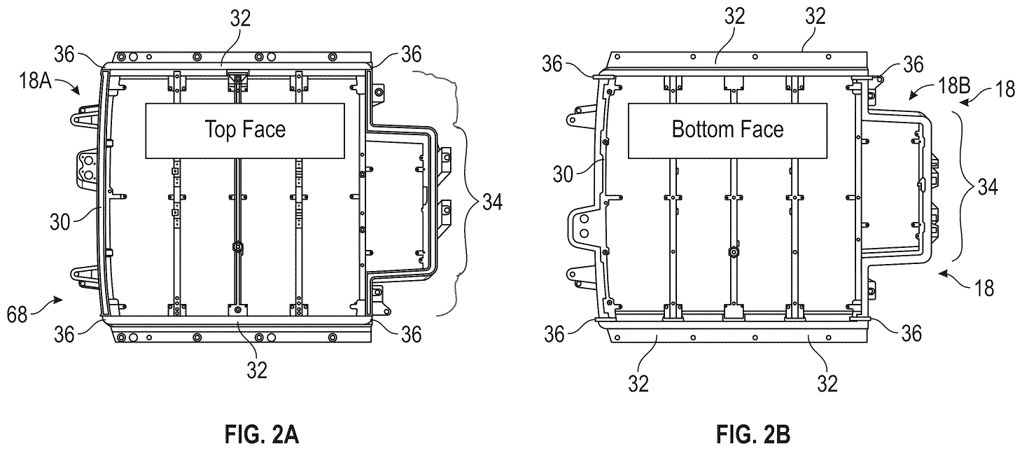

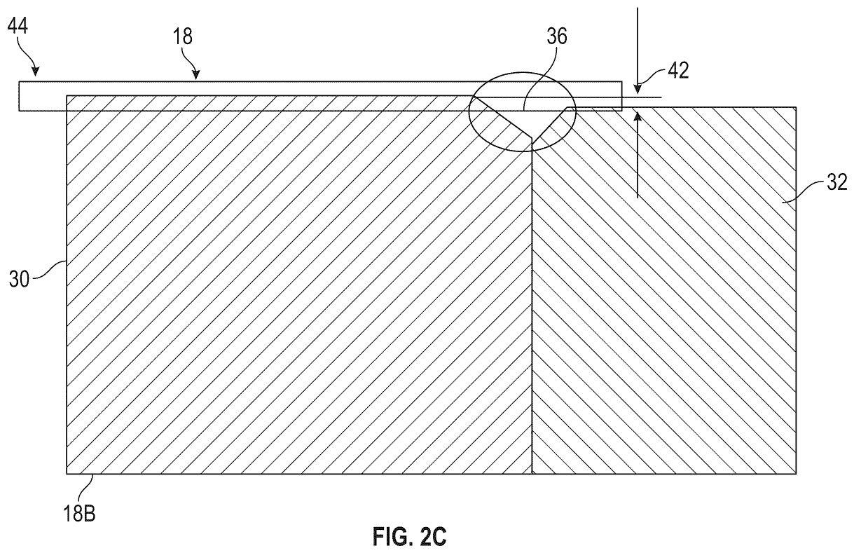

Referring now to FIG. 2A, a top surface 18A having a front or first beam 30, side beams 32 and a rear or second beam 34 is set forth. In this example, the beam 30, the beam 34 and welds 36 therebetween are machined relative to the side beams.

Referring now to FIG. 2B, the bottom surface 18B of the battery tray 18 is illustrated in further detail. The beams 30, 32 are formed so that any differences are manifested in the top surface. However, welds 36 have various locations which are used to hold different beams together. On the bottom surface 18B, the welds 36 are machined in other examples. The welds 36 are formed on both top and bottom sides.

Referring now to FIG. 2C, an intersection 40 between the front beam 30 and a side beam 32 is illustrated having the weld 36. FIG. 2C3 presumes the bottom face 18B is flat and therefore no machining takes place. The measurement system 20, as described below, is ultimately used to determine a cutting depth 42 and a milling area 44 in which the cutting depth is to be reached. In this example, a significant portion of the front beam is removed to be co-planar with the top surface 18A of the side beam 32.

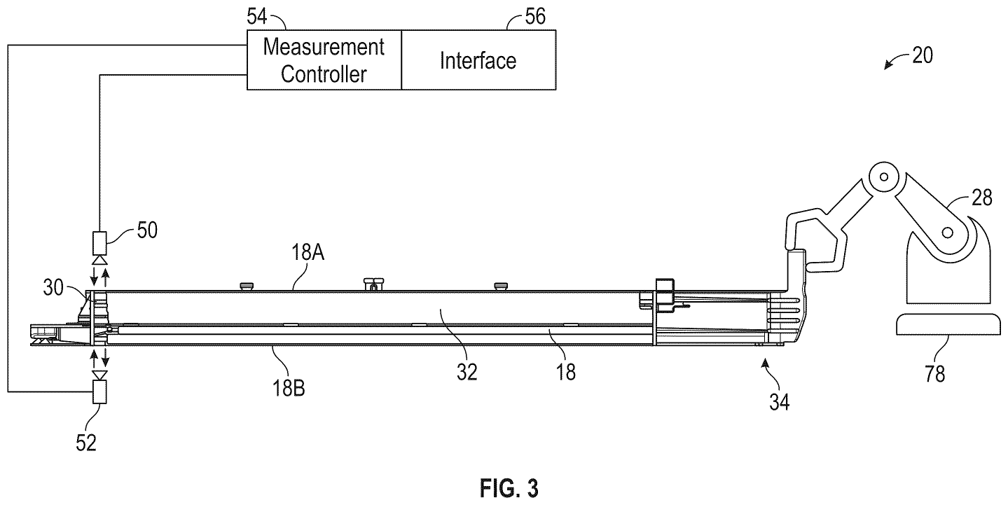

Referring now to FIG. 3, the measurement system 20 is illustrated in greater detail relative to the battery tray 18. More specifically, a side beam 32 is illustrated relative to a front beam 30 and a rear beam 34. In this example, a first measurement device 50 is used to scan the upper surface 18A of the battery tray 18. A lower measuring device 52 is used to scan the bottom surface 18B of the tray 18. As mentioned above, depending upon the formation of the battery tray 18, only one measuring device such as the upper measuring device 50 are used.

In this example, the scanning is performed by laser devices such as laser cameras as the measuring devices 50, 52. In one example, each laser device 50, 52 moves relative to the battery tray 18. In another example, the robot 28 moves the battery tray 18 between the measurement devices 50, 52 prior to inserting them in the machining station 10. As mentioned above, the measurement system 20 has a measurement controller 54 that determines the measurements of the top surface 18A and the bottom surface 18B, if needed. A milling area 44 is determined so that the measured cutting depth 42 are determined at the measurement controller 54. Ultimately, an interface 56 communicates the measurement to controller 22 of the machining station 10. This allows the time consuming measurements to be done prior to insertion within the machinery station 10. By providing measurements prior to machining station 10, cycle times increase and therefore the capital cost of a second machining station that is not required since the measurement is performed outside of the machining station 10.

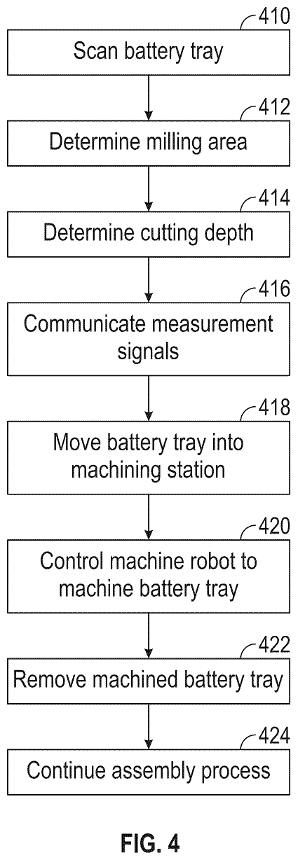

Referring now to FIG. 4, a method of operating the battery tray system 8 is illustrated. In this example, the battery tray 18 that was previously welded is scanned using the measurement devices 50 and/or 52. The scanning of the battery tray in step 410 takes place by moving the battery tray 18 and/or the measurement devices 50, 52. In step 412, the measurement system 20 determines the milling area based upon the scan from step 410. Based on the milling area, a cutting depth is determined in step 414. Once the milling area is determined in step 410 and the cutting depth is determined in step 414, the measurement signals that include the milling area position and the cutting depth are communicated to the machining station in step 416. In step 418, after the measurements are performed in step 412 and 414, the battery tray 18 is moved into the machining station 10. In step 420, the machining robot is controlled to perform machining in the milling area to the cutting depth. As mentioned above, the difference between adjacent beams and welding seams are machined based upon the measurements.

In step 422, once the battery tray is machined, it is removed from the machining robot in step 422. The movement of the battery tray 18 into the machining station and out of the machining station are performed by various robots including the movement robot 28 described above.

In one example, the cycle time was reduced from 80 seconds to 63 seconds. The yearly volume for battery trays is very high and therefore the reduction in cycle time reduces the need for two milling machines so that only one milling machine is needed. The reduction stems from prior machining cells measuring the battery tray prior to machining but within the machining station 10.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of machining a battery tray for an electric vehicle comprising:
scanning a surface of the battery tray in a measurement system;
generating a measurement signal based on scanning;
communicating the measurement signal to a machining machine;
inserting a battery tray into the machining machine, said battery tray comprising a weld and a beam;
machining the weld and the beam based on the measurement signal.

2. The method of claim 1 wherein machining comprises milling.

3. The method of claim 1 wherein inserting the battery tray comprises inserting the battery tray comprising a plurality of welds and wherein machining comprises machining the plurality of welds.

4. The method of claim 1 wherein inserting the battery tray comprises inserting the battery tray comprising a plurality of welds, a front beam and a rear beam and wherein machining comprises machining the plurality of welds, the front beam and the rear beam.

5. The method of claim 1 wherein scanning the surface of the battery tray comprises scanning a top surface of the battery tray.

6. The method of claim 5 wherein scanning the surface of the battery tray comprises scanning a bottom surface of the battery tray.

7. The method of claim 6 wherein scanning the top surface of the battery tray comprises scanning the top surface using a first laser device.

8. The method of claim 7 wherein scanning comprises scanning the bottom surface of the battery tray comprises scanning the bottom surface using a second laser device.

9. The method of claim 1 wherein generating the measurement signal comprises determining a cutting depth and wherein machining comprises machining to the cutting depth.

10. The method of claim 1 wherein generating the measurement signal comprises determining a milling area and a cutting depth and wherein machining comprises machining the milling area to the cutting depth.

11. A system for processing a battery tray comprising:
a machining robot disposed within a machine frame, said robot comprising a robot controller; and
a measurement system disposed outside the machine frame and generating a battery tray measurement signal and communicating the battery tray measurement signal to the machining robot;
said machining robot machining the battery tray based on the battery tray measurement signal.

12. The system of claim 11 wherein the machining robot comprises a milling robot.

13. The system of claim 11 wherein the battery tray comprises a plurality of welds and the machining robot machines the plurality of welds.

14. The system of claim 11 wherein the battery tray comprises a plurality of welds, a front beam and a rear beam and wherein the machining robot machines the plurality of welds, the front beam and the rear beam.

15. The system of claim 11 wherein measurement system scans a top surface of the battery tray.

16. The system of claim 15 wherein measurement system scans a bottom of the battery tray.

17. The system of claim 6 wherein the measurement system comprises a first laser device.

18. The system of claim 17 wherein the measurement system comprises a second laser device.

19. The system of claim 11 wherein the measurement signal comprises a cutting depth.

20. The system of claim 11 wherein the measurement signal comprises a cutting depth of a milling area and a cutting depth.
